(19) United States
(12) Patent Application Publication
(10) Pub. No.: US 2022/0261836 A1
(43) Pub. Date: Aug. 18, 2022

(54) USAGE CHARGE SETTING APPARATUS, USAGE CHARGE SETTING METHOD, AND STORAGE MEDIUM

(71) Applicant: TOYOTA JIDOSHA KABUSHIKI KAISHA, Toyota-shi (JP)

(72) Inventors: Shigeki KINOMURA, Toyota-shi (JP); Kenji NAKAO, Toyota-shi (JP); Yoshiyuki TSUCHIYA, Toyota-shi (JP)

(73) Assignee: TOYOTA JIDOSHA KABUSHIKI KAISHA, Toyota-shi (JP)

(21) Appl. No.: 17/591,274

(22) Filed: Feb. 2, 2022

(30) Foreign Application Priority Data
Feb. 12, 2021 (JP) 2021-020871

(51) Int. Cl. G06Q 30/02; G06Q 50/30

(52) U.S. Cl. CPC G06Q 30/0214; G06Q 50/30

(57) ABSTRACT

There is provided a usage charge setting apparatus configured to set a usage charge of a shared use service for a vehicle that is able to participate in a demand response and that is used for the shared use service. This usage charge setting apparatus sets the usage charge of the shared use service, based on a reward relating to the demand response and a profit relating to the shared use service. This configuration ensures the gross profit of the owner of the vehicle.

### CROSS-REFERENCE TO RELATED APPLICATION

The present disclosure claims priority to Japanese Patent Application No. 2021-020871 filed on Feb. 12, 2021, which is incorporated herein by reference in its entirety including specification, drawings and claims.

### TECHNICAL FIELD

The present disclosure relates to a usage charge setting apparatus, a usage charge setting method, and a storage medium.

### BACKGROUND

A computer-implemented method of performing a demand response (DR) has been proposed (as described in, for example, JP 2018-136929A). This computer-implemented method receives a DR-related demand request signal including a DR parameter. The DR parameter includes a reduction of energy consumption and a DR incentive price. This computer-implemented method also determines a vehicle-specific incentive price range including a first incentive price and a second incentive price that is smaller than the first incentive price, with regard to each of a plurality of vehicles. The first incentive price and the second incentive price are amounts of money set to cause each vehicle to positively approve participation in the DR. The vehicle-specific incentive price range is set, based on a DR profile of each vehicle. This computer-implemented method furthermore selects vehicles to form a vehicle subgroup, out of the plurality of vehicles, such as to maximize the number of vehicles participating in the DR and to maximize the profit of each of the vehicles included in the vehicle subgroup, based on the vehicle-specific incentive price range with regard to each of the plurality of vehicles under the condition of the DR incentive price. Additionally, this computer-implemented method sends a DR signal to each of the vehicles included in the vehicle subgroup.

### SUMMARY

The computer-implemented method described above, however, does not at all take into account the case where the vehicle participating in the DR is used for a shared use service, such as a car sharing service or a car rental service. With a view to ensuring the gross profit of an owner of a vehicle (for example, an operation company of a shared use service) that is able to participate in the DR and that is used for the shared use service, there is an issue of how to set a usage charge of the shared use service for the vehicle.

A usage charge setting apparatus, a usage charge setting method, and a storage medium of the present disclosure mainly aim to ensure a gross profit of an owner of a vehicle that is able to participate in a demand response and that is used for a shared use service.

In order to achieve the main object described above, the usage charge setting apparatus, the usage charge setting method, and the storage medium are implemented by aspects described below.

According to one aspect of the present disclosure, there is provided a usage charge setting apparatus configured to set a usage charge of a shared use service for a vehicle that is able to participate in a demand response and that is used for the shared use service. This usage charge setting apparatus sets the usage charge of the shared use service, based on a reward relating to the demand response and a profit relating to the shared use service.

The usage charge setting apparatus according to this aspect of the present disclosure sets the usage charge of the shared use service, based on the reward relating to the demand response and the profit relating to the shared use service. This configuration sets the usage charge of the shared use service by taking into account the reward relating to the demand response and the profit relating to the shared use service and thereby ensures the gross profit of the owner of the vehicle (for example, the operation company of the shared use service). The shared use service herein includes a car sharing service and a car rental service.

According to another aspect of the present disclosure, there is provided a usage charge setting method of setting a usage charge of a shared use service for a vehicle that is able to participate in a demand response and that is used for the shared use service. The usage charge setting method sets the usage charge of the shared use service, based on a reward relating to the demand response and a profit relating to the shared use service.

The usage charge setting method according to this aspect of the present disclosure sets the usage charge of the shared use service, based on the reward relating to the demand response and the profit relating to the shared use service. This configuration sets the usage charge of the shared use service by taking into account the reward relating to the demand response and the profit relating to the shared use service and thereby ensures the gross profit of the owner of the vehicle (for example, the operation company of the shared use service). The shared use service herein includes a car sharing service and a car rental service.

According to another aspect of the present disclosure, there is provided a storage medium that stores a program configured to cause a computer to perform the usage charge setting method according to the above aspect of the present disclosure, i.e., the usage charge setting method that basically sets a usage charge of a shared use service for a vehicle that is able to participate in a demand response and that is used for the shared use service or more specifically the usage charge setting method that sets the usage charge of the shared use service, based on a reward relating to the demand response and a profit relating to the shared use service.

The storage medium according to this aspect of the present disclosure stores the program that causes the computer to perform the usage charge setting method according to the above aspect of the present disclosure. The storage medium of this aspect accordingly has similar advantageous effects to those of the usage charge setting method described above, for example, the advantageous effect of ensuring the gross profit of the owner of the vehicle (for example, the operation company of the shared use service).

### BRIEF DESCRIPTION OF DRAWINGS

FIG. 1 is a block diagram illustrating a demand response system 10 provided with a usage charge setting apparatus according to one embodiment of the present disclosure; and

FIG. 2 is a flowchart showing one example of a usage charge setting program performed by a vehicle management server 38.

### DESCRIPTION OF EMBODIMENTS

Some aspects of the present disclosure are described below with reference to embodiments.

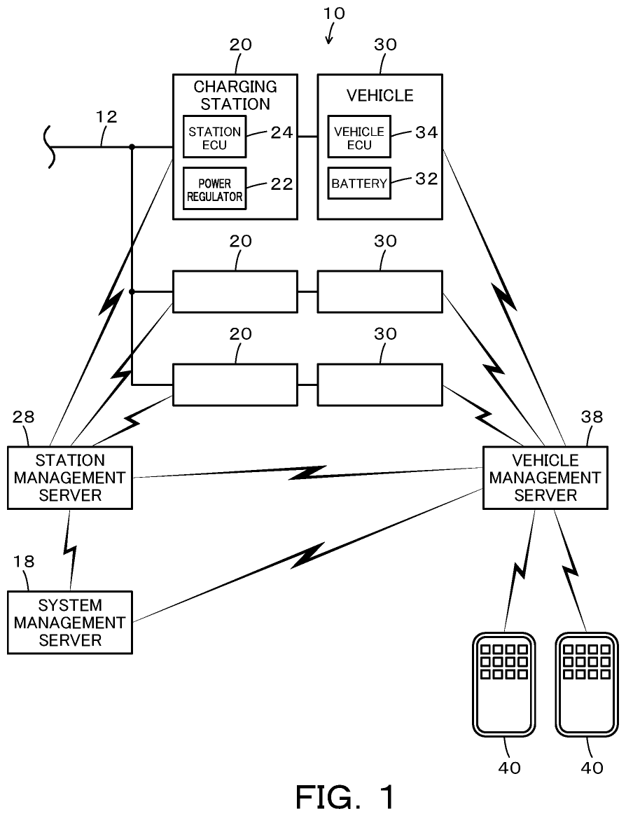

FIG. 1 is a block diagram illustrating a demand response (hereinafter referred to as “DR”) system 10 provided with a usage charge setting apparatus according to one embodiment of the preset disclosure. As illustrated, the DR system 10 of the embodiment includes a power system 12, a system management server 18, a plurality of charging stations 20, a station management server 28, a plurality of vehicles 30 that are allowed to participate in the DR and that are used for shared use service, a vehicle management server 38 and users' mobile terminals 40. The shared use service herein includes, for example, car sharing service and car rental service. The number of the charging stations 20 and the number of the vehicles 30 are respectively three in FIG. 1. These numbers are, however, not limited to this numeral but may be any numeral, such as 1, 2, 5, or 10. The vehicle management server 38 corresponds to the usage charge setting apparatus according to the embodiment.

The power system 12 is a power system including, for example, a power plant, business facilities, factories and homes. The system management server 18 is, for example, a server used for management of the power system 12 by a power company. This system management server 18 includes, for example, a CPU, a ROM, a RAM, a flash memory, a storage device (an SSD, a hard disk or the like), input/output ports, and a communication port. The system management server 18 is configured to make wireless communication with the station management server 28 and with the vehicle management server 38. A variety of programs, for example, a DR participation incentive program, are installed in the system management server 18. The DR participation incentive program is a program of setting a DR participation incentive for each time zone and sending relevant DR participation incentive information to the vehicle management server 38. The DR participation incentive is an incentive (reward) to a vehicle that participates in the DR (including a vehicle that is not used for the shared use service). The vehicle that participates in the DR is, for example, a vehicle that enters into a DR participation contract and that is connected with the power system 12 via the charging station 20 (including the vehicle that is not used for the shared use service) with regard to each time zone.

The charging station 20 is connected with the power system 12 and includes a power regulator 22 and a station electronic control unit (hereinafter referred to as “station ECU”) 24 configured to control the power regulator 22. The power regulator 22 is configured to regulate the electric power when battery charging is performed or battery discharging is performed in the state that a vehicle-side connector of the vehicle 30 is connected with a station-side connector of the charging station 20. The battery charging herein means that the electric power of the power system 12 is supplied to a battery 32 of the vehicle 30 via the charging station 20 to charge the battery 32. The battery discharging herein means that the electric power of the battery 32 is supplied to the power system 12 via the charging station 20. The station ECU 24 includes, for example, a CPU, a ROM, a RAM, a flash memory, input/output ports, and a communication port. The station ECU 24 is configured to make wireless communication with the station management server 28 and is also configured to make wired or wireless communication with an vehicle electronic control unit (hereinafter referred to as “vehicle ECU”) 34 of each vehicle 30.

The station management server 28 is a server used for management of the charging station 20 by an owner of the charging station 20 (for example, a management company of the charging station). This station management server 28 includes, for example, a CPU, a ROM, a RAM, a flash memory, a storage device (an SSD, a hard disk or the like), input/output ports, and a communication port. The station management server 28 is configured to make wireless communication with the system management server 18, the station ECUs 24 of the charging stations 20, and the vehicle management server 38. A variety of programs are installed in the station management server 28.

The vehicle 30 is configured as an electric vehicle and includes a motor for running, the battery 32 configured to transmit electric power to and from the motor, and the vehicle ECU 34 configured to drive the motor and to manage the battery 32. The vehicle ECU 34 includes, for example, a CPU, a ROM, a RAM, a flash memory, input/output ports, and a communication port. The vehicle ECU 34 is configured to make wireless communication with the vehicle management server 38 and is also configured to make wired or wires communication with the station ECUs 24 of the charging stations 20. The vehicle ECU 34 calculates a state of charge SOC of the battery 32, based on the electric current of the battery 32 detected by a current sensor that is mounted to an output terminal of the battery 32. The vehicle 30 is configured to perform the battery charging or the battery discharging described above, when the vehicle-side connector of the vehicle 30 is connected with the station-side connector of the charging station 20.

The vehicle 30 is not limited to the electric vehicle but may be configured as a hybrid vehicle equipped with an engine in addition to the motor, the battery 32, and the vehicle ECU 34, or may be configured as a fuel cell vehicle equipped with a fuel cell in addition to the motor, the battery 32, and the vehicle ECU 34.

The vehicle management server 38 is a server used for management of the vehicle 30 by an owner of the vehicle 30 (for example, an operation company of the shared use service). This vehicle management server 38 includes, for example, a CPU, a ROM, a RAM, a flash memory, a storage device (an SSD, a hard disk or the like), input/output ports, and a communication port. The vehicle management server 38 is configured to make wireless communication with the system management server 18, the station management server 28, the vehicle ECUs 34 of the vehicles 30 and the mobile terminals 40. A variety of programs, for example, a usage charge setting program, are installed in the vehicle management server 38. The usage charge setting program is a program of setting usage charges of the shared use service with regard to respective time zones and of updating a web page including the set usage charges.

The mobile terminal 40 is configured as, for example, a smartphone or a tablet terminal. Each mobile terminal 40 is configured to make wireless communication with the vehicle management server 38. A variety of applications, for example, an application for the shared use service are installed in the mobile terminal 40. The application for the shared use service is an application used to access the web page updated by the vehicle management server 38, so as to check the usage charges of the shared use service with regard to the respective time zones and make a reservation for using the vehicle 30.

In the DR system 10 of the embodiment, the owner of the vehicle 30 (for example, the operation company of the shared use service) uses the vehicle 30 for the shared use service and appropriately causes the vehicle 30 to participate in the DR (appropriately enters into a DR participation contract). When the vehicle 30 participates in the DR, the DR proceeds, for example, as described below. The system management server 18 sends power regulation requests to the charging stations 20 via the station management server 28 and to the vehicles 30 via the vehicle management sever 38 as needed basis, with a view to regulating and stabilizing the supply and demand of the power system 12. When receiving the power regulation request, the vehicle 30 starts the battery charging or the battery discharging described above or stops the battery charging or the battery discharging in an available range, based on the state of charge SOC of the battery 32. Accordingly, the vehicle 30 serves as a virtual power plant (hereinafter referred to as “VPP”). In this case, the vehicle 30 is used as V2G (performing both the battery charging and the battery discharging) or as V1G (performing only the battery charging). According to the embodiment, the vehicle 30 is connected with the charging station 20 (the power system 12) after being used for the shared use service according to the regulations and the rules of the shared use service or the like.

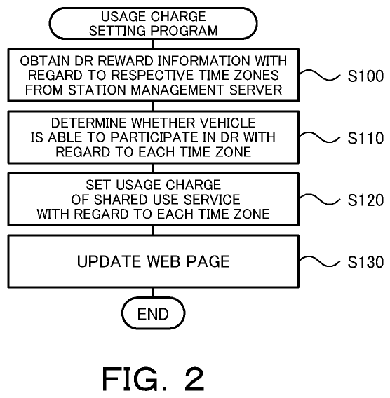

The following describes the operations of the DR system 10 of the embodiment and more specifically the operations of the vehicle management server 38. FIG. 2 is a flowchart showing one example of the usage charge setting program performed by the vehicle management server 38. The vehicle management server 38 performs the usage charge setting program each day to set the usage charges of the shared use service with regard to respective time zones in a next day and to update the web page including the set usage charges.

When the usage charge setting program of FIG. 2 is started, the vehicle management server 38 first obtains DR participation incentive information with regard to each time zone in a next day from the system management server 18 (step S100). The system management server 18 performs a DR participation incentive program each day to set DR participation incentives with regard to respective time zones in a next day and to send relevant DR participation incentive information to the vehicle management server 38. The DR participation incentive is set with regard to each time zone in a next day, based on predicted values of power supply and demand of the power system 12 and is set, for example, like A yen/h in a time period from a time X to a time Y and B yen/h in a time period from the time Y to a time Z.

The vehicle management server 38 subsequently determines whether each vehicle 30 is able to participate in the DR with regard to each time zone in the next day (step S110). More specifically, the vehicle management server 38 obtains vehicle information, for example, the parking position of the vehicle and connection or disconnection of the vehicle-side connector of the vehicle 30 with or from the station-side connector of the charging station 20, from the vehicle 30, assumes that the vehicle 30 is not used for the shared use service, and determines whether the vehicle 30 is able to participate in the DR with regard to each time zone in the next day, based on the obtained vehicle information. The vehicle management server 38 then makes a DR participation contract for the vehicle 30 with regard to each participable time zone when the vehicle 30 is able to participate in the DR. The DR participation contract is made, for example, as follows. In the case of an operation company owning a small number of vehicles, the DR participation contact is made individually for each vehicle 30. In the case of an operation company owning a large number of vehicles, on the other hand, the DR participation contact is made collectively for at least part of the vehicles 30 owned by the operation company (for example, about several ten to several hundred vehicles 30).

The vehicle management server 38 also sets the usage charges of the shared use service with regard to respective time zones in the next day (step S120). More specifically, in the case where there is any participable time zone when the vehicle 30 is able to participate in the DR, the vehicle management server 38 specifies an amount of money determined by subtracting overhead costs from the usage charge of the shared use service as a service-related profit relating to the shared use service, specifies a DR-related reward (incentive) relating to the DR as a DR participation incentive, and sets the usage charge of the shared use service such as to make the service-related profit equal to or larger than the DR-related reward, with regard to each of the participable time zones. For example, the vehicle management server 38 sets the usage charge of the shared use service to an amount of money determined by adding overhead costs of the shared use service to the DR-related reward (DR participation incentive) or to an amount of money determined by adding overhead costs of the shared use service and some markup to the DR-related reward. The markup may be set appropriately. In the case where there is any non-participable time zone when the vehicle 30 is not able to participate in the DR, the vehicle management server 38 sets the usage charge of the shared use service to a relatively low price with regard to each of the non-participable time zones. This is because the vehicle 30 in this state does not gain the DR participation incentive even when the vehicle 30 is not used for the shared use service.

When the vehicle 30 is used for the shared use service, the owner of the vehicle 30 (for example, the operation company of the shared use service) gains the service-related profit that is the amount of money determined by subtracting the overhead costs from the usage charge of the shared use service. When the vehicle 30 is not used for the shared use service, on the other hand, the owner of the vehicle 30 causes the vehicle 30 to participate in the DR and gains the DR participation incentive (the DR-related reward). According to the embodiment, the vehicle management server 38 takes into account the foregoing and sets the usage charge of the shared use service, such as to make the service-related profit equal to or larger than the DR-related reward, with regard to each of the participable time zones when the vehicle 30 is able to participate in the DR. This ensures the gross profit for the owner of the vehicle 30.

After setting the usage charges of the shared use service with regard to the respective time zones in the next day, the vehicle management server 38 updates a web page including the set usage charges (step S130) and then terminates this routine. Each user accesses the web page by using an application for the shared use service in the mobile terminal 40 to check the usage charges of the shared use service with regard to the respective time zones in the next day and to make a reservation for using the vehicle 30.

In the DR system 10 of the embodiment described above, the vehicle management server 38 as the usage charge setting apparatus sets the usage charge of the shared use service such as to make the service-related profit equal to or larger than the DR-related reward with regard to each of the participable time zones when the vehicle 30 is able to participate in the DR. This ensures the gross profit for the owner of the vehicle (for example, the operation company of the shared use service).

According to the embodiment, the vehicle management server 38 specifies the amount of money determined by subtracting the overhead costs from the usage charge of the shared use service as the service-related profit and sets the usage charge of the shared use service such as to make the service-related profit equal to or larger than the DR-related reward, with regard to each of the participable time zones when the vehicle 30 is able to participate in the DR. Increasing the usage charge of the shared use service is expected to decrease the service utilization rate of the vehicle 30 for the shared use service. It is also expected that the service utilization rate differs, depending on the time zone, the day of week and the season. According to a modification, instead of specifying the amount of money determined by subtracting the overhead costs from the usage charge of the shared use service as the service-related profit, the vehicle management server 38 may specify an amount of money (expected value of profit) determined by multiplying the amount of money that is obtained by subtracting the overhead costs from the usage charge of the shared use service, by a predicted value of the service utilization rate, as the service-related profit. The predicted value of the service utilization rate is set, for example, based on past statistical data. This configuration enables the service-related profit and thereby the usage charge of the shared use service to be more appropriately set by taking into account the predicted value of the service utilization rate.

According to the embodiment, the vehicle management server 38 specifies the DR-related reward as the DR participation incentive and sets the usage charge of the shared use service such as to make the service-related profit equal to or larger than the DR-related reward, with regard to each of the participable time zones when the vehicle 30 is able to participate in the DR. In some cases, the DR participation incentive may be not uniform for all the vehicles participating in the DR but may differ between a VPP time when the vehicle actually serves as the VPP and a non-VPP time when the vehicle does not actually serve as the VPP. The VPP time is, for example, a time when the vehicle 30 receives a power regulation request and performs the battery charging or the battery discharging. The non-VPP time is, for example, a time when the vehicle 30 does not receive a power regulation request or a time when the vehicle 30 does not perform the battery charging or the battery discharging based on the conditions, such as the state of charge SOC of the battery 32, regardless of receiving a power regulation request. It is expected that a VPP probability, i.e., a probability that the vehicle participating in the DR actually serves as the VPP, differs, depending on the time zone, the day of week and the season. According to a modification, instead of specifying the DR-related reward as the DR participation incentive (uniform incentive), the vehicle management server 38 may set the DR-related reward to an amount of money (expected value of reward), based on the DR participation incentives (different incentives in the VPP time and in the non-VPP time) and a predicted value of the VPP probability. The predicted value of the VPP probability is set, for example, based on past statistical data. More concretely, the expected value of reward is obtained as a sum of a product of the incentive in the VPP time and the predicted value of the VPP probability and a product of the incentive in the non-VPP time and a value calculated by subtracting the predicted value of the VPP probability from a value of 1. When the reward in the non-VPP time is equal to zero, the expected value of reward is obtained as a product of the reward in the VPP time and the predicted value of the VPP probability. This configuration enables the DR-related reward and thereby the usage charge of the shared use service to be more appropriately set by taking into account the predicted value of the VPP probability.

According to the embodiment, the vehicle management server 38 specifies the amount of money determined by subtracting the overhead costs from the usage charge of the shared use service as the service-related profit, specifies the DR-related reward as the DR participation incentive, and sets the usage charge of the shared use service such as to make the service-related profit equal to or larger than the DR-related reward, with regard to each of the participable time zones when the vehicle 30 is able to participate in the DR. According to the modifications described above, the vehicle management server 38 sets the service-related profit to the amount of money (expected value of profit) determined by multiplying the amount of money that is obtained by subtracting the overhead costs from the usage charge of the shared use service, by the predicted value of the service utilization rate, or sets the DR-related reward to the amount of money (expected value of reward), based on the DR participation incentives (different incentives in the VPP time and in the non-VPP time) and the predicted value of the VPP probability. According to another modification, these configurations may be combined with each other, and the vehicle management server 38 may set the service-related profit to the expected value of profit and set the DR-related reward to the expected value of reward. This configuration enables the service-related profit and the DR-related reward and thereby the usage charge of the shared use service to be more appropriately set.

According to the embodiment, the vehicle management server 38 sets the usage charge of the shared use service such as to make the service-related profit equal to or larger than the DR-related reward, with regard to each of the participable time zones when the vehicle 30 is able to participate in the DR. In the case where the vehicle 30 is not able to participate in the DR after a DR participation contract is made for the vehicle 30 (for example, in the case where the vehicle 30 is used for the shared use service), there may be a penalty for breach of the contract (hereinafter referred to as “penalty”). According to a modification, the vehicle management server 38 may set the usage charge of the shared use service, such as to make the service-related profit taking into account the penalty equal to or larger than the DR-related reward. In this case, the penalty may be included in the overhead costs of the shared use service or may be separate from the overhead costs, depending on the type of the DR participation contract. For example, in the case of an operation company that owns a small number of the vehicles 30 and that enters into the DR participation contract individually for the respective vehicles 30, the service-related profit may be set to an amount of money determined by subtracting the overhead costs and the penalty from the usage charge of the shared use service. In the case of an operation company that owns a large number of the vehicles 30 and that enters into the DR participation contract collectively for at least part of the vehicles 30 owned by the operation company, for example, about several ten to several hundred vehicles 30, the service-related profit may be set to an amount of money determined by subtracting the overhead costs (including, for example, an amount of money determined by dividing the penalty by the number of vehicles that enter into the contract) from the usage charge of the shared use service. This configuration enables the service-related profit and thereby the usage charge of the shared use service to be more appropriately set by taking into account the penalty.

According to the embodiment, the vehicle management server 38 sets the usage charge of the shared use service such as to make the service-related profit equal to or larger than the DR-related reward, with regard to each of the participable time zones when the vehicle 30 is able to participate in the DR. The incentive in the VPP time included in the DR participation incentive may differ between battery charging and battery discharging. For example, in the case where a charge incentive for battery charging is higher than a discharge incentive for battery discharging, the lower state of charge SOC of the battery 32 of the vehicle 30 has a higher expected value of reward in the VPP time, compared with the higher state of charge SOC. In this case, the vehicle management server 38 may accordingly set the higher usage charge of the shared use service in the lower state of charge SOC, compared with that in the higher state of charge SOC. In another example, in the case where the discharge incentive is higher than the charge incentive, the higher state of charge SOC of the battery 32 of the vehicle 30 has a higher expected value of reward in the VPP time, compared with the lower state of charge SOC. In this case, the vehicle management server 38 may accordingly set the higher usage charge of the shared use service in the higher state of charge SOC, compared with that in the lower state of charge SOC. This configuration enables the usage charge of the shared use service to be set according to the state of charge SOC of the battery 32. This configuration also encourages the vehicle 30 to participate in the DR in the case of the high expected value of reward in the VPP time, while encouraging the vehicle 30 to be used for the shared use service in the case of the low expected value of reward in the VPP time.

In the embodiment and the modifications described above, the vehicle management server 38 specifies the DR participation incentive (uniform incentive) as the DR-related reward or specifies the amount of money (expected value of reward) based on the DR participation incentives (different incentives in the VPP time and the non-VPP time) and the predicted value of the VPP probability as the DR-related reward, and sets the usage charge of the shared use service such as to make the service-related profit equal to or larger than the DR-related reward, with regard to each of the participable time zones when the vehicle 30 is able to participate in the DR. In some cases, the DR participation reward may differ among locations, as well as among time zones. In this case, the usage charge of the shared use service may be set with regard to each time zone, by taking into account a place of departure of the vehicle 30 (a place where the vehicle 30 is rented) and a scheduled destination of the vehicle 30 (a scheduled place where the vehicle 30 is returned).

For example, it is assumed that the DR participation incentive in a business district is higher than the DR participation incentive in a residential district during the daytime and that the DR participation incentive in the residential district is higher than the DR participation incentive in the business district during the nighttime. In this case, during the daytime, the usage charge of the shared use service may be set to be lower in the case where the scheduled destination is in the business district, compared with the usage charge in the case where the scheduled destination is in the residential district. During the nighttime, on the other hand, the usage charge of the shared use service may be set to be lower in the case where the scheduled destination is in the residential district, compared with the usage charge in the case where the scheduled destination is in the business district. This configuration encourages the user to use the vehicle 30 by the shared use service from the business district or from the residential district to the business district during the daytime, while encouraging the user to use the vehicle 30 by the shared use service from the business district or from the residential district to the residential district during the nighttime. This configuration accordingly encourages the vehicle 30 to participate in the DR in the business district during the daytime, while encouraging the vehicle 30 to participate in the DR in the residential district during the nighttime. As a result, this increases the DR participation incentive.

In another example, it is assumed that a residential district has a large number of the vehicles 30 and that a business district has a small number of the vehicles 30. In this case, the usage charge of the shared use service may be set to be lower in the case where the place of departure is in a residential district and the scheduled destination is in a business district, compared with the usage charges in the other cases. This configuration encourages the user to use the vehicle 30 by the shared use service from the residential district to the business district. This configuration accordingly encourages the vehicle 30 to be moved to the place having the small number of the vehicles 30 by the shared use service. A similar configuration is applicable to the case where a business district has a large number of the vehicles 30 and a residential district has a small number of the vehicles 30.

In another example, it is assumed that not only a place where the vehicle 30 is able to participate in the DR (a place where the charging station 20 is located) but a place where the vehicle 30 is not able to participate in the DR (a place where no charging station 20 is located) is allowed to be specified as the scheduled destination of the vehicle 30 (the scheduled place where the vehicle 30 is returned) by the shared use service. In this case, the usage charge of the shared use service may be set to be higher in the case where the scheduled destination of the vehicle 30 is the place where the vehicle 30 is not able to participate in the DR, compared with the usage charge in the case where the scheduled destination is the place where the vehicle 30 is able to participate in the DR. This configuration encourages the user to specify the place where the vehicle 30 is able to participate in the DR, as the scheduled destination of the vehicle 30.

According to the embodiment, the system management server 18 sets the DR participation incentives each day with regard to the respective time zones in a next day, and the vehicle management server 38 sets the usage charges of the shared use service each day with regard to the respective time zones in a next day. The system management server 18 is, however, not limited to this configuration but may have any configuration that sets the DR participation incentives with regard to respective future time zones. For example, the system management server 18 may be configured to set the DR participation incentives with regard to respective time zones after the current time this day or with regard to respective time zones in a day after tomorrow or later. The vehicle management server 38 is also not limited to the above configuration but may have any configuration that sets the usage charges of the shared use service with regard to respective future time zones. For example, the vehicle management server 38 may be configured to set the usage charges of the shared use service with regard to respective time zones after the current time this day or with regard to respective time zones in a day after tomorrow or later.

The DR system 10 of the embodiment includes the system management server 18, the station management server 28 and the vehicle management server 38. At least two of these servers may be configured by an integral server. For example, the owner of the charging stand 20 may be identical with the owner of the vehicle 30, and the station management server 28 and the vehicle management server 38 may be configured by an integral server.

The above embodiment describes the vehicle management server 38 as the usage charge setting apparatus that is one aspect of the present disclosure. The present disclosure may also be implemented as other aspects, i.e., a usage charge setting method and a storage medium that stores a program configured to cause a computer to perform the usage charge setting method.

The usage charge setting apparatus according to the above aspect of the present disclosure may set the usage charge of the shared use service, such as to make the profit relating to the shared use service equal to or larger than the reward relating to the demand response. This configuration more appropriately ensures the gross profit for the owner of the vehicle. For example, when the reward relating to the demand response is a participation incentive for the vehicle that participates in the demand response and the profit relating to the shared use service is an amount of money determined by subtracting overhead costs from the usage charge of the shared use service, the usage charge of the shared use service may be set to an amount of money determined by adding overhead costs of the shared use service to the participation incentive or to an amount of money determined by adding overhead costs of the shared use service and a markup to the participation incentive.

In the usage charge setting apparatus according to the above aspect of the present disclosure, the profit relating to the shared use service may be an amount of money (expected value of profit) that takes into account a predicted value of a service utilization rate of the vehicle for the shared use service. In this aspect, the profit relating to the shared use service may be an amount of money determined by multiplying the amount of money that is obtained by subtracting the overhead costs from the usage charge of the shared use service, by the predicted value of the service utilization rate. These configurations enable the usage charge of the shared use service to be more appropriately set by taking into account the predicted value of the service utilization rate.

In the usage charge setting apparatus according to the above aspect of the present disclosure, the reward relating to the demand response may be an amount of money (expected value of reward) that takes into account a predicted value of a plant probability that the vehicle actually serves as a virtual power plant in the demand response. In this aspect, the reward relating to the demand response may be a total amount of money that is a sum of a product of a first reward when the vehicle actually serves as the virtual power plant in the demand response and the predicted value of the plant probability and a product of a second reward when the vehicle does not actually serve as the virtual power plant in the demand response and a value obtained by subtracting the predicted value of the plant probability from a value of 1. These configurations enable the usage charge of the shared use service to be more appropriately set by taking into account the predicted value of the plant probability.

The usage charge setting apparatus according to the above aspect of the present disclosure may set the usage charge of the shared use service, based on a charge incentive for charging of a power storage device of the vehicle and a discharge incentive for discharging of the power storage device by the demand response and on a state of charge of the power storage device. In this aspect, when the charge incentive by the demand response is higher than the discharge incentive by the demand response, the usage charge of the shared use service in the case of the low state of charge may be set to be higher than the usage charge in the case of the high state of charge. When the discharge incentive by the demand response is higher than the charge incentive by the demand response, on the other hand, the usage charge of the shared use service in the case of the high state of charge may be set to be higher than the usage charge in the case of the low state of charge. These configurations enable the usage charge of the shared use service to be more appropriately set by taking into account the charge incentive and the discharge incentive by the demand response and the state of charge of the power storage device.

The usage charge setting apparatus according to the above aspect of the present disclosure may set the usage charge of the shared use service by taking into account a place of departure and/or a scheduled destination of the vehicle that is used for the shared use service. In this aspect, when the reward relating to the demand response is higher in a first place than the reward in a second place, the usage charge of the shared use service may be set lower in the case where the scheduled destination is the first place, compared with the usage charge in the case where the scheduled destination is the second place. Furthermore, when the first place has a larger number of the vehicles used for the shared use service than the second place, the usage charge of the shared use service may be set lower in the case where the place of departure is the first place and the scheduled destination is the second place, compared with the usage charge in the other cases. Moreover, the usage charge of the shared use service may be set higher in the case where the scheduled destination is a place where the vehicle is not able to participate in the demand response, compared with the usage charge in the case where the scheduled destination is a place where the vehicle is able to participate in the demand response. These configurations enable the usage charge of the shared use service to be more appropriately set by taking into account the place of departure and/or the scheduled destination.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The present disclosure is applicable to shared use service industries and the like.

What is claimed is:

1. A usage charge setting apparatus configured to set a usage charge of a shared use service for a vehicle that is able to participate in a demand response and that is used for the shared use service,
the usage charge setting apparatus being configured to set the usage charge of the shared use service, based on a reward relating to the demand response and a profit relating to the shared use service.

2. The usage charge setting apparatus according to claim 1,
the usage charge setting apparatus being configured to set the usage charge of the shared use service, such as to make the profit relating to the shared use service equal to or larger than the reward relating to the demand response.

3. The usage charge setting apparatus according to claim 1,
wherein the profit relating to the shared use service is an amount of money that takes into account a predicted value of a service utilization rate of the vehicle for the shared use service.

4. The usage charge setting apparatus according to claim 1,
wherein the reward relating to the demand response is an amount of money that takes into account a predicted value of a plant probability that the vehicle actually serves as a virtual power plant in the demand response.

5. The usage charge setting apparatus according to claim 1,
the usage charge setting apparatus being configured to set the usage charge of the shared use service, based on a charge incentive for charging of a power storage device of the vehicle and a discharge incentive for discharging of the power storage device by the demand response and on a state of charge of the power storage device.

6. The usage charge setting apparatus according to claim 1,
the usage charge setting apparatus being configured to set the usage charge of the shared use service by taking into account a place of departure and/or a scheduled destination of the vehicle that is used for the shared use service.

7. A usage charge setting method of setting a usage charge of a shared use service for a vehicle that is able to participate in a demand response and that is used for the shared use service,
the usage charge setting method setting the usage charge of the shared use service, based on a reward relating to the demand response and a profit relating to the shared use service.

8. A storage medium that stores a program configured to cause a computer to perform the usage charge setting method according to claim 7.
